(19) United States
(12) Patent Application Publication
(10) Pub. No.: US 2025/0342241 A1
(43) Pub. Date: Nov. 6, 2025

(54) PASSKEY SERVICE PROVISION METHOD THAT ENSURES COMPATIBILITY BETWEEN OS VERSIONS, AND APPARATUS FOR IMPLEMENTING THE SAME

(71) Applicant: SAMSUNG SDS CO., LTD., Seoul (KR)

(72) Inventors: Si Wan Bae, Seoul (KR); Dong Ho Kim, Seoul (KR); Hong Chul Lee, Seoul (KR)

(73) Assignee: SAMSUNG SDS CO., LTD., Seoul (KR)

(21) Appl. No.: 19/193,313

(22) Filed: Apr. 29, 2025

(30) Foreign Application Priority Data
May 2, 2024 (KR) 10-2024-0058467

(51) Int. Cl. G06F 21/45; G06F 8/71; G06F 9/54

(52) U.S. Cl. CPC G06F 21/45; G06F 8/71; G06F 9/541

(57) ABSTRACT

The present disclosure according to at least one embodiment provides a passkey service provision apparatus comprising a service application, a passkey agent, and a passkey agent library configured to deliver a request from the service application to the passkey agent, wherein the service application is configured to generate a passkey authentication request by calling the passkey agent library, and the passkey agent library is configured to: deliver the passkey authentication request to the passkey agent using an inter-process communication (IPC) method when an operating system (OS) version of the passkey service provision apparatus is lower than a predefined version, and deliver the passkey authentication request to the passkey agent by calling a passkey authentication Application Programming Interface (API) provided by the OS when the OS version of the passkey service provision apparatus is equal to or higher than the predefined version.

### CROSS-REFERENCE TO RELATED APPLICATION

This application claims priority from Korean Patent Application No. 10-2024-0058467 filed on May 2, 2024, in the Korean Intellectual Property Office, and all the benefits accruing therefrom under 35 U.S.C. 119, the contents of which in its entirety are herein incorporated by reference.

### BACKGROUND

### 1. Field

The present disclosure relates to a passkey service provision method that ensures compatibility between different Operating System (OS) versions, and an apparatus for implementing the same, and more specifically, to a passkey service provision method that ensures compatibility between different OS versions so as to enable the support of passkey generation and authentication services even on OS versions that do not natively support such services, and an apparatus for implementing the same.

### 2. Description of the Related Art

To address the security vulnerabilities of password-based user account authentication, there has recently been growing interest in passkey services, which provide passwordless user account authentication through Fast Identity Online (FIDO) authentication.

In line with this trend, various platforms such as Windows, Android, and iOS have begun officially supporting passkeys.

In mobile applications, the generation and authentication of passkeys are performed through requests and responses between a relying party (RP) application and a passkey provider application.

Currently, in the Android SDK Library provided by Google, passkey generation and authentication via a passkey provider are supported only on OS version 14 or higher. On Android version 13 or lower, passkeys can be generated only through Google Play Services, and passkey generation through other passkey providers is not possible.

Accordingly, even if a passkey provider service is established, it cannot be provided to users of Android devices running OS version 13 or lower.

Therefore, it is necessary to ensure backward compatibility of OS versions so that passkey generation and authentication functions can be supported on Android version 13 or lower in the same manner as on version 14 or higher.

In addition, when switching to a device running Android version 14 or higher, a technology is required that allows passkeys issued on Android version 13 or lower to be used without requiring re-registration.

### SUMMARY

One objective of the present disclosure is to provide a passkey service provision method that ensures compatibility between operating system (OS) versions so as to support passkey generation and authentication functions regardless of the OS version, and an apparatus for implementing the same.

Another objective of the present disclosure is to provide a passkey service provision method that ensures compatibility between OS versions such that, even when switching to a device running a higher OS version, passkeys used in the previous device can be used as is without requiring re-registration, and an apparatus for implementing the same.

Yet another objective of the present disclosure is to provide a passkey service provision method that ensures compatibility between OS versions such that, even when switching to a device running a higher OS version, previously registered passkeys can be used without a separate registration process by using a passkey synchronization function, and an apparatus for implementing the same.

The objectives of the present disclosure are not limited to those mentioned above, and other objectives not explicitly stated will be clearly understood by those skilled in the art based on the following description.

According to an aspect of the present disclosure, there is provided a passkey service provision apparatus comprising a service application, a passkey agent, and a passkey agent library configured to deliver a request from the service application to the passkey agent, wherein the service application is configured to generate a passkey authentication request by calling the passkey agent library, and the passkey agent library is configured to: deliver the passkey authentication request to the passkey agent using an inter-process communication (IPC) method when an operating system (OS) version of the passkey service provision apparatus is lower than a predefined version, and deliver the passkey authentication request to the passkey agent by calling a passkey authentication Application Programming Interface (API) provided by an OS when the OS version of the passkey service provision apparatus is equal to or higher than the predefined version.

In some embodiments, when the OS version of the passkey service provision apparatus is lower than the predefined version, the passkey agent library may be further configured to convert request data included in the passkey authentication request into first intent information and deliver the first intent information to the passkey agent.

In some embodiments, the passkey agent may be configured to: convert the delivered first intent information into a format identical to that of the passkey authentication API provided by the OS, process the passkey authentication request, generate first intent result information as a response to the passkey authentication request, and deliver the first intent result information to the passkey agent library.

In some embodiments, the passkey agent may be further configured to process the passkey authentication request by providing a custom user interface (UI) identical to a system popup called by the OS.

In some embodiments, the passkey agent library may be further configured to return, to the service application, a value obtained by converting the first intent result information into the format identical to that of the passkey authentication API.

In some embodiments, the passkey agent may be further configured to: determine whether a passkey for processing the passkey authentication request exists after converting the delivered first intent information into the format identical to that of the passkey authentication API, and when the passkey does not exist, generate intent result information indicating failure to process the passkey authentication request as a response to the first intent information and deliver the intent result information to the passkey agent library.

In some embodiments, the passkey agent library may be further configured to return, to the service application, a value obtained by converting the intent result information indicating failure to process the passkey authentication request into the format identical to that of the passkey authentication API, the service application may be further configured to generate a passkey generation request by calling the passkey agent library, and the passkey agent library may be further configured to deliver the passkey generation request to the passkey agent using the IPC method.

In some embodiments, wherein when the OS version of the passkey service provision apparatus is lower than the predefined version, the passkey agent library may be further configured to convert request data included in the passkey generation request into second intent information and deliver the second intent information to the passkey agent, the passkey agent may be further configured to: convert the delivered second intent information into the format identical to that of the passkey authentication API provided by the OS, process the passkey generation request; and generate second intent result information as a response to the passkey generation request and deliver the second intent result information to the passkey agent library, and the passkey agent library may be further configured to return, to the service application, a value obtained by converting the second intent result information into the format identical to that of the passkey authentication API.

In some embodiments, before the generation of the passkey authentication request by the service application, the passkey agent library may be further configured to: deliver an account inquiry request generated by the service application to the passkey agent, obtain, from the passkey agent, information on whether a user account is activated from the passkey agent and notify the service application of the obtained information as a response to the account inquiry request, and when the user account is determined not to be activated, allow the passkey agent to perform registration and authentication of the user account by delivering an account activation request generated by the service application to the passkey agent.

In some embodiments, the passkey agent library may be further configured to perform verification on a request generated by the service application by communicating with a service server that provides services to the service application, and the passkey agent may be further configured to store, in a secure area of the OS, information on a passkey generated in response to the request from the service application by communicating with a passkey provider server that provides a passkey management service.

According to another aspect of the present disclosure, there is provided a passkey service provision method that provides compatibility between operating system (OS) versions, performed by a computing device including a service application, a passkey agent, and a passkey agent library. The passkey service provision method comprises: generating, by the service application, a passkey authentication request by calling the passkey agent library, delivering, by the passkey agent library, the passkey authentication request to the passkey agent using an inter-process communication (IPC) method when an operating system (OS) version of the computing device is lower than a predefined version, and delivering, by the passkey agent library, the passkey authentication request to the passkey agent by calling a passkey authentication Application Programming Interface (API) provided by an OS when the OS version of the computing device is equal to or higher than the predefined version.

In some embodiments, the delivering of the passkey authentication request to the passkey agent using the IPC method may comprise: converting, by the passkey agent library, request data included in the passkey authentication request into first intent information; and delivering the first intent information to the passkey agent.

In some embodiments, the method further comprises: converting, by the passkey agent, the delivered first intent information into a format identical to that of the passkey authentication API provided by the OS, processing, by the passkey agent, the passkey authentication request, generating, by the passkey agent, first intent result information as a response to the passkey authentication request, and delivering the first intent result information to the passkey agent library.

In some embodiments, the processing of the passkey authentication request may comprise processing, by the passkey agent, the passkey authentication request by providing a custom user interface (UI) identical to a system popup called by the OS.

In some embodiments, the method may further comprise: returning, by the passkey agent library, a value obtained by converting the first intent result information into the format identical to that of the passkey authentication API to the service application.

According to another aspect of the present disclosure, there is provided a computing device comprising: at least one processor, a memory configured to load a computer program executed by the at least one processor, and a storage configured to store the computer program, wherein the computer program includes instructions for performing operations of: generating a passkey authentication request by having a service application call a passkey agent library, delivering the passkey authentication request to a passkey agent using an inter-process communication (IPC) method when an operating system (OS) version of the computing device is lower than a predefined version, and delivering the passkey authentication request to the passkey agent by calling a passkey authentication Application Programming Interface (API) provided by the OS when the OS version of the computing device is equal to or higher than the predefined version.

In some embodiments, the delivering of the passkey authentication request to the passkey agent using the IPC method may comprise: converting, by the passkey agent library, request data included in the passkey authentication request into first intent information; and delivering the first intent information to the passkey agent.

In some embodiments, the computer program may further include instructions for performing operations of: converting, by the passkey agent, the delivered first intent information into a format identical to that of the passkey authentication API provided by the OS, and processing the passkey authentication request, and generating first intent result information as a response to the passkey authentication request, and delivering the first intent result information to the passkey agent library.

In some embodiments, the processing of the passkey authentication request may comprise processing, by the passkey agent, the passkey authentication request by providing a custom user interface (UI) identical to a system popup called by the OS.

In some embodiments, the computer program may further include instructions for performing an operation of: returning, by the passkey agent library, a value obtained by converting the first intent result information into the format identical to that of the passkey authentication API to the service application.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is a block diagram illustrating the configuration of a system for providing a passkey service according to an embodiment of the present disclosure;

FIG. 2 illustrates a process in which a passkey agent library processes a passkey generation request or a passkey authentication request depending on the operating system (OS) version, according to an embodiment of the present disclosure;

FIG. 3 illustrates the process of FIG. 2 in further detail;

FIG. 4 is a flowchart illustrating a passkey service provision method that ensures compatibility between OS versions, according to an embodiment of the present disclosure;

FIG. 5 illustrates a process for account activation prior to passkey generation, according to some embodiments of the present disclosure;

FIG. 6 illustrates passkey generation and authentication processes on Android version 13 or lower, according to some embodiments of the present disclosure;

FIG. 7 illustrates passkey generation and authentication processes on Android version 14 or higher, according to some embodiments of the present disclosure;

FIG. 8 illustrates exemplary login screens by OS version, according to some embodiments of the present disclosure; and

FIG. 9 is a diagram illustrating the hardware configuration of an exemplary computing device capable of implementing methods according to embodiments of the present disclosure.

### DETAILED DESCRIPTION

Hereinafter, preferred embodiments of the present disclosure will be described with reference to the attached drawings. The advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, some embodiments of the present disclosure will be described in detail with reference to the accompanying drawings.

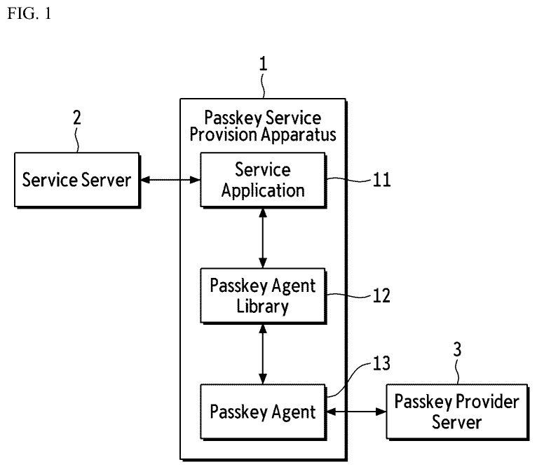

FIG. 1 is a block diagram illustrating the configuration of a system for providing a passkey service according to an embodiment of the present disclosure.

Referring to FIG. 1, the system for providing a passkey service according to an embodiment of the present disclosure includes a passkey service provision apparatus 1, a service server 2, and a passkey provider server 3. The passkey service provision apparatus 1 is connected to each of the service server 2 and the passkey provider server 3 via a network.

The passkey service provision apparatus 1 is an apparatus for providing a passkey service that enables user authentication without a password by using biometric authentication such as fingerprint recognition or PIN entry, and may be, for example, a mobile terminal such as a smartphone or tablet, or a PC.

The passkey service provision apparatus 1 includes a service application 11, a passkey agent library 12, and a passkey agent 13.

The passkey agent 13 may be connected to the passkey provider server 3 via a network to perform transmission and reception of data for passkey generation and authentication. The passkey agent 13 may also provide information regarding passkeys received from the passkey provider server 3 via a management screen.

Meanwhile, the service application 11 may be connected to the service server 2 via a network to transmit and receive data for service provision, and may request verification by transmitting a result of passkey generation or authentication to the service server 2 in response to a login request.

The service application 11 may transmit a passkey generation request or a passkey authentication request to the passkey agent 13 for processing via the passkey agent library 12 during user registration or login.

Specifically, the service application 11 may generate a passkey generation request or a passkey authentication request by calling the passkey agent library 12. At this time, the passkey agent library 12 may deliver the passkey generation or authentication request to the passkey agent 13 in different methods depending on the operating system (OS) version of the passkey service provision apparatus 1.

In one embodiment, if the OS version of the passkey service provision apparatus 1 is equal to or higher than a predefined version, the passkey agent library 12 may deliver the passkey authentication request to the passkey agent 13 by invoking a passkey authentication Application Programming Interface (API) provided by the OS.

However, if the OS version of the passkey service provision apparatus 1 is lower than the predefined version, the passkey agent library 12 may deliver the passkey authentication request to the passkey agent 13 using inter-process communication (IPC).

According to the aforementioned system configuration, compatibility between OS versions can be provided, enabling support for passkey generation and authentication functions regardless of OS version.

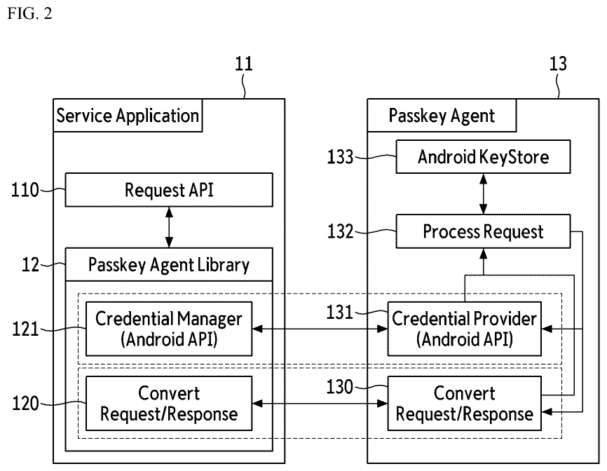

FIG. 2 illustrates a process in which a passkey agent library processes a passkey generation request or a passkey authentication request depending on the OS version, according to an embodiment of the present disclosure.

Referring to FIG. 2, the service application 11, upon a user login request, delivers a passkey authentication request or a passkey generation request to the passkey agent library 12 by calling an API provided by the OS regardless of OS version, as indicated by reference numeral 110.

In one embodiment, if the OS version of the passkey service provision apparatus 1 is Android 14 or higher, the passkey agent library 12 may deliver the passkey authentication or generation request to the passkey agent 13 using a Credential Manager API 121 or 131 provided by Android, and may receive the result of processing the passkey authentication or generation request via the passkey agent 13, as indicated by reference numeral 132.

Meanwhile, if the OS version of the passkey service provision apparatus 1 is Android 13 or lower, the passkey agent library 12 may convert the request data into intent information using a Convert Request/Response module 120 and transmit the intent information to the passkey agent 13.

In this case, the passkey agent 13 may process the passkey authentication or generation request, as indicated by reference numeral 132, by converting the received intent information into a format identical to that of a Software Development Kit (SDK) provided on Android 14 or higher using a Convert Request/Response module 130, and may deliver the result of the processing to the passkey agent library 12 by converting it back.

During the process in which the passkey agent library 12 transmits a request to and receives the result from the passkey agent 13 as described above, it may perform verification on the request and the result through communication with the service server 2. The passkey agent 13 may store passkey information obtained through communication with the passkey provider server 3 in an Android Keystore 133.

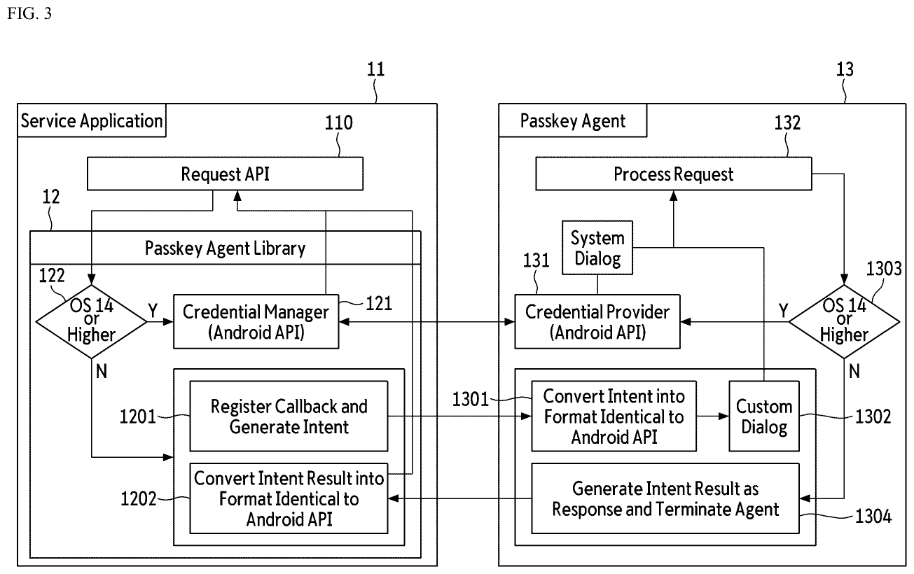

FIG. 3 illustrates the process of FIG. 2 in further detail.

Referring to FIG. 3, the service application 11 delivers a passkey authentication request or a passkey generation request to the passkey agent library 12 by calling an API provided by the OS, as indicated by reference numeral 110.

At this time, the passkey agent library 12 identifies whether the OS version is Android 14 or higher, as indicated by reference numeral 122. If the OS version is identified as Android 14 or higher, the passkey agent library 12 delivers the passkey authentication or generation request to the passkey agent 13 using the Credential Manager API 121 provided by Android. The passkey agent 13 may then process the passkey authentication or generation request through a system dialog provided by Android, as indicated by reference numeral 132, and deliver the result of the request processing to the passkey agent library 12 using the Credential Manager API 131.

Meanwhile, if the OS version is identified as lower than Android 14, the passkey agent library 12 registers a callback in a first library module 1201 to receive a result of request processing, generates a passkey authentication request or a passkey generation request as intent information, and delivers the intent information to a first agent module 1301 of the passkey agent 13.

In this case, the passkey agent 13 converts the received intent information into a format identical to that of an Android API in the first agent module 1301 and processes the passkey authentication or generation request through a custom dialog 1302, as indicated by reference numeral 132.

Thereafter, the passkey agent 13 generates intent result information as a response to the request processing, in a second agent module 1304, delivers the intent result information to the passkey agent library 12, and then terminates the passkey agent 13.

Accordingly, the passkey agent library 12 returns, to the service application 11, a value obtained by converting the intent result information received from the second library module 1202 into the format identical to that of the Android API.

According to this embodiment, even when the OS version is a lower version that does not natively support passkey services, passkey generation and authentication functions can be supported by using a passkey agent library that provides compatibility between OS versions.

Accordingly, if the OS version is updated on the same terminal, each passkey used in a previous version can be used as is, without requiring re-registration. In addition, even when switching to a device running a higher OS version, previously registered passkeys can be used without a separate registration process by utilizing a passkey synchronization function.

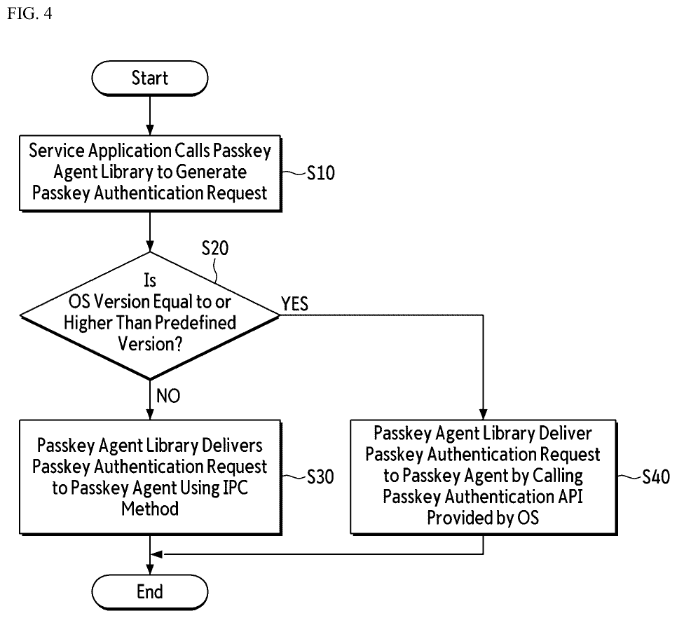

FIG. 4 is a flowchart illustrating a passkey service provision method that ensures compatibility between OS versions, according to an embodiment of the present disclosure.

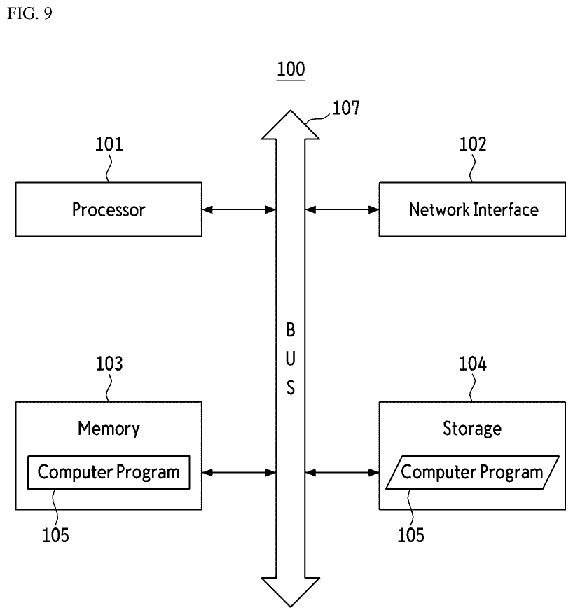

The passkey service provision method according to an embodiment of the present disclosure may be executed by the passkey service provision apparatus 1 illustrated in FIG. 1 or by a computing device 100 illustrated in FIG. 9. The computing device 100 executing the passkey service provision method of this embodiment may be a computing device equipped with an application execution environment. The computing device 100 may be, for example, a device capable of performing computing functions, such as a smartphone, tablet, or PC.

It is noted that, in methods according to embodiments of the present disclosure, the description of an entity performing some operations or steps may be omitted, in which case, the entity may be the computing device 100.

According to the passkey service provision method of this embodiment, passkey generation and authentication functions can be supported regardless of the OS version by applying a passkey agent library that provides compatibility between OS versions when providing passkey services.

Referring to FIG. 4, in step S10, the computing device 100 generates a passkey authentication request by having the service application 11 call the passkey agent library 12.

Thereafter, in step S20, the computing device 100 identifies whether the OS version is equal to or higher than a predefined version.

If it is identified in step S20 that the OS version is equal to or higher than the predefined version, then in step S40, the passkey agent library 12 of the computing device 100 delivers the passkey authentication request to the passkey agent 13 by calling a passkey authentication API provided by the OS.

Conversely, if it is identified in step S20 that the OS version is lower than the predefined version, then in step S30, the passkey agent library 12 delivers the passkey authentication request to the passkey agent 13 using IPC.

In one embodiment, when performing step S30, the passkey agent library 12 may convert request data included in the passkey authentication request into first intent information and deliver the first intent information to the passkey agent 13.

The passkey agent 13 may convert the delivered first intent information into a format identical to that of the passkey authentication API provided by the OS and process the passkey authentication request. At this time, the passkey agent 13 may process the passkey authentication request by providing a custom user interface identical to a system popup called by the OS.

Thereafter, in response to the processing of the passkey authentication request being complete, the passkey agent 13 may generate first intent result information as a response to the passkey authentication request and deliver it to the passkey agent library 12.

Finally, the passkey agent library 12 returns, to the service application 11, a value obtained by converting the first intent result information into the format identical to that of the passkey authentication API.

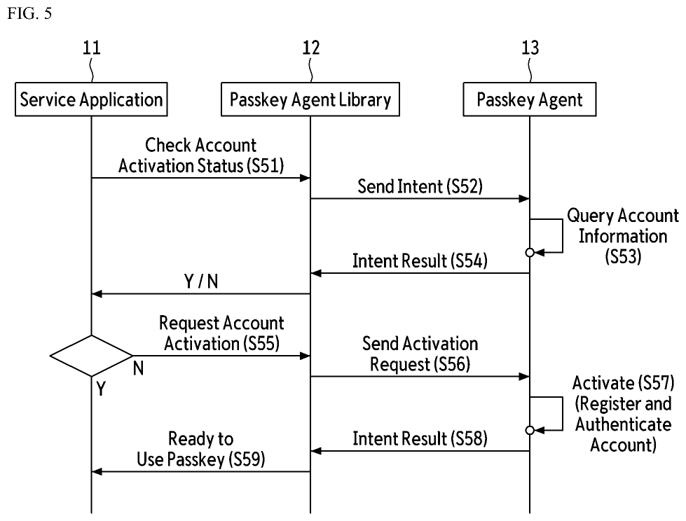

FIG. 5 illustrates a process for account activation prior to passkey generation, according to some embodiments of the present disclosure.

Referring to FIG. 5, in order for the passkey agent 13 to generate a passkey, prior authentication for the account of the service application 11 needs to be performed first.

Specifically, as illustrated, when the service application 11 delivers an account inquiry request to the passkey agent library 12 to determine the activation status of the account (S51), the passkey agent library 12 generates intent information including the account inquiry request and delivers it to the passkey agent 13 (S52).

The passkey agent 13 inquires about the account information using the intent information (S53), generates intent result information including information regarding the activation status of the account as a response, and delivers the intent result information to the passkey agent library 12 (S54). The delivered intent result information is then returned to the service application 11.

At this time, if it is determined that the user account is not in an activated state based on the returned intent result information, the service application 11 generates an account activation request and delivers it to the passkey agent library 12 (S55).

Thereafter, when the passkey agent library 12 delivers the received account activation request to the passkey agent 13, user account registration and authentication are performed in the passkey agent 13 to activate the account, and the result of the user account registration and authentication is returned to the service application 11 via the passkey agent library 12.

According to this embodiment, user account registration and authentication can be performed in the passkey agent 13 before the generation of a passkey.

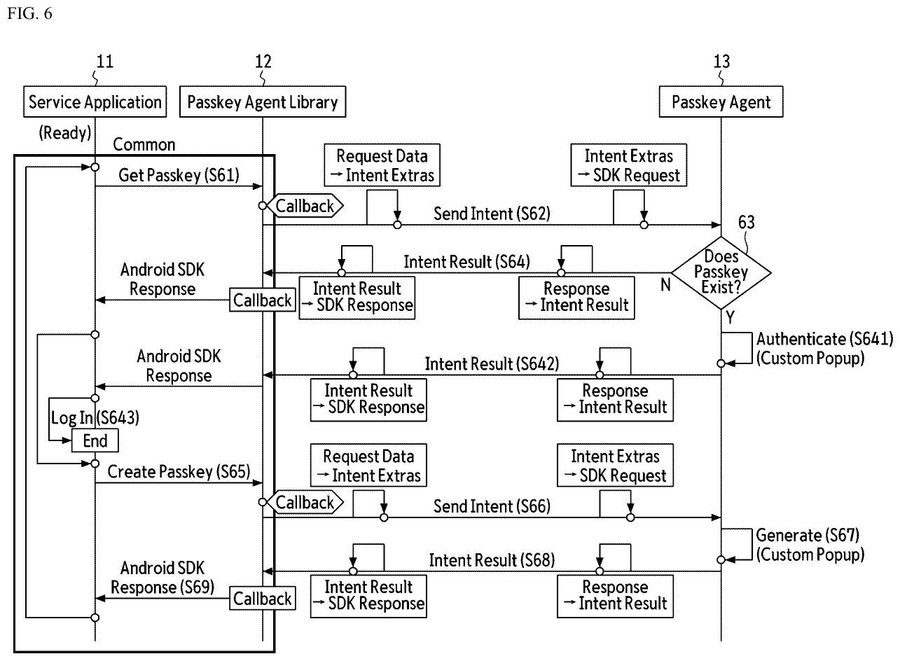

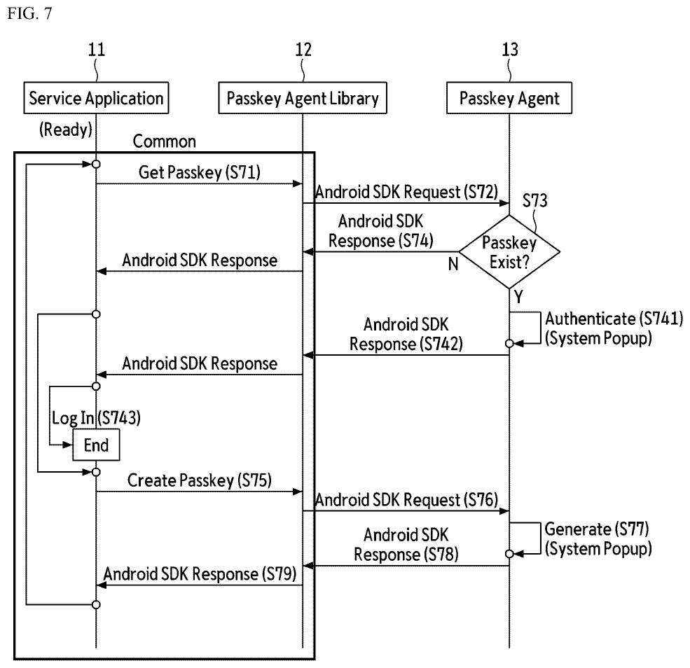

Passkey generation and authentication processes on Android version 13 or lower and on Android version 14 or higher will hereinafter be described with reference to FIGS. 6 and 7.

FIG. 6 illustrates passkey generation and authentication processes on Android version 13 or lower, according to some embodiments of the present disclosure.

Referring to FIG. 6, when the service application 11 delivers a passkey authentication request to the passkey agent library 12 (S61), the passkey agent library 12 generates intent information including the received passkey authentication request and delivers the intent information to the passkey agent 13 (S62).

Thereafter, the passkey agent 13 converts the received intent information into a format identical to that of an SDK provided by the Android OS (e.g., a passkey authentication API) and determines whether a passkey for processing the passkey authentication request exists (S63).

If it is determined that a passkey exists (Y), the passkey agent 13 processes the passkey authentication request through a custom popup identical to a system popup provided by the Android OS (S641), and generates intent result information as a response and delivers it to the passkey agent library 12 (S642).

Accordingly, when the passkey agent library 12 returns, to the service application 11, a value obtained by converting the received intent result information into the format identical to that of the SDK provided by the Android OS, login to the service application 11 is successfully completed (S643).

However, if it is determined that no passkey exists (N), the passkey agent 13 generates intent result information indicating failure to process the passkey authentication request and delivers it to the passkey agent library 12 as a response to the intent information (S64).

The passkey agent library 12 returns, to the service application 12, a value obtained by converting the intent result information indicating failure to process the passkey authentication request into the format identical to that of the SDK provided by the Android OS.

Accordingly, the service application 12 calls the passkey agent library 12 to generate a passkey generation request (S65), and the passkey agent library 12 delivers the passkey generation request to the passkey agent 13 using IPC.

At this time, the passkey agent library 12 generates intent information including the passkey generation request and delivers the intent information to the passkey agent 13 (S66), and the passkey agent 13 processes the passkey generation request (S67) by converting the received intent information into the format identical to that of the SDK provided by the Android OS.

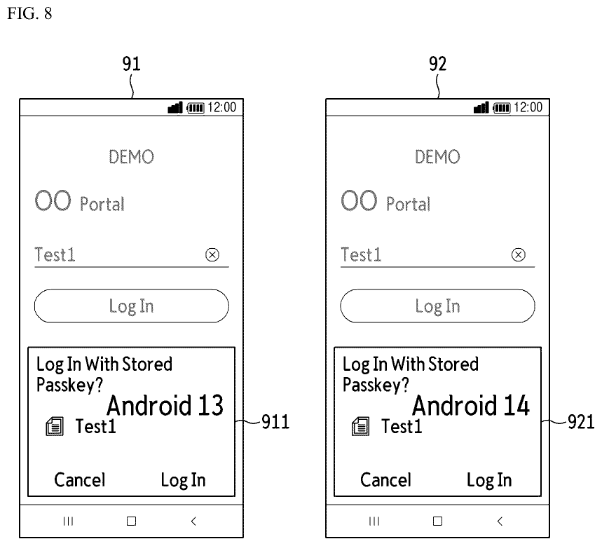

The passkey agent 13 processes the passkey generation request through a custom popup (“911” in FIG. 8) identical to a system popup provided by the Android OS, and generates intent result information as a response and delivers it to the passkey agent library 12 (S68).

Accordingly, when the passkey agent library 12 returns, to the service application 11, a value obtained by converting the received intent result information into the format identical to that of the SDK provided by the Android OS (S69), the process for handling the passkey generation request is terminated.

According to this embodiment, even when the OS version is a lower version that does not natively support passkey services, passkey authentication and generation functions can be supported by applying a passkey agent library that provides both a function for converting a request from a service application into a format identical to that of an SDK provided by the OS and a function for processing the request through a custom popup identical to a system popup provided by the OS.

FIG. 7 illustrates passkey generation and authentication processes on Android version 14 or higher, according to some embodiments of the present disclosure.

Referring to FIG. 7, when the service application 11 delivers a passkey authentication request to the passkey agent library 12 (S71), the passkey agent library 12 delivers the passkey authentication request to the passkey agent 13 by calling an API provided by Android (S72).

Thereafter, the passkey agent 13 determines whether a passkey for processing the passkey authentication request exists (S73).

If it is determined that the passkey exists (Y), the passkey agent 13 requests the processing of the passkey authentication request through a system popup provided by the Android OS (S741) and delivers the response to the passkey agent library 12 by calling the API provided by Android (S742).

Accordingly, when the passkey agent library 12 returns the received response to the service application 11, login to the service application 11 is successfully completed (S743).

However, if it is determined that the passkey does not exists (N), the passkey agent 13 delivers a response indicating failure to process the passkey authentication request to the passkey agent library 12 by calling the API provided by Android (S74).

The passkey agent library 12 returns the response indicating failure to process the passkey authentication request to the service application 12.

Accordingly, the service application 12 generates a passkey generation request by calling the passkey agent library 12 (S75), and the passkey agent library 12 delivers the passkey generation request to the passkey agent 13 by calling the API provided by Android (S76).

At this time, the passkey agent 13 processes the received passkey generation request through a system popup (“921” in FIG. 8) provided by the Android OS (S77), and delivers the response to the passkey agent library 12 by calling the API provided by Android (S78).

Accordingly, when the passkey agent library 12 returns the received response to the service application 11 (S79), the process for handling the passkey generation request is terminated.

According to this embodiment, even when the OS version is a lower version that does not natively support passkey services, passkey generation and authentication functions can be supported by applying a passkey agent library that ensures compatibility between OS versions.

FIG. 9 is a hardware configuration diagram of an exemplary computing device 100.

Referring to FIG. 9, the computing device 100 may include one or more processors 101, a bus 107, a network interface 102, a memory 103, which loads a computer program 105 executed by the processors 101, and a storage 104 for storing the computer program 105.

The processor 101 controls overall operations of each component of computing device 100. The processor 101 may be configured to include at least one of a Central Processing Unit (CPU), a Micro Processor Unit (MPU), a Micro Controller Unit (MCU), a Graphics Processing Unit (GPU), or any type of processor well known in the art. Further, the processor 101 may perform calculations on at least one application or program for executing a method/operation according to various embodiments of the present disclosure. The computing device 100 may have one or more processors.

The memory 103 stores various data, instructions and/or information. The memory 103 may load one or more programs 105 from the storage 104 to execute methods/operations according to various embodiments of the present disclosure. An example of the memory 103 may be a RAM, but is not limited thereto.

The bus 107 provides communication between components of computing device 100. The bus 107 may be implemented as various types of bus such as an address bus, a data bus and a control bus.

The network interface 102 supports wired and wireless internet communication of the computing device 100. The network interface 102 may support various communication methods other than internet communication. To this end, the network interface 102 may be configured to comprise a communication module well known in the art of the present disclosure.

The storage 104 can non-temporarily store one or more computer programs 105. The storage 104 may be configured to comprise a non-volatile memory, such as a Read Only Memory (ROM), an Erasable Programmable ROM (EPROM), an Electrically Erasable Programmable ROM (EEPROM), a flash memory, a hard disk, a removable disk, or any type of computer readable recording medium well known in the art.

In one embodiment, the computer program 105 may include instructions for performing the operations of: generating a passkey authentication request by having a service application call a passkey agent library; delivering the passkey authentication request to a passkey agent via IPC when the OS version of the computing device 100 is lower than a predefined version; and delivering the passkey authentication request to the passkey agent by calling a passkey authentication API provided by the OS when the OS version of the computing device is equal to or higher than the predefined version.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk).

The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A passkey service provision apparatus comprising:
a service application;
a passkey agent; and
a passkey agent library configured to deliver a request from the service application to the passkey agent,
wherein
the service application is configured to generate a passkey authentication request by calling the passkey agent library, and
the passkey agent library is configured to: deliver the passkey authentication request to the passkey agent using an inter-process communication (IPC) method when an operating system (OS) version of the passkey service provision apparatus is lower than a predefined version; and deliver the passkey authentication request to the passkey agent by calling a passkey authentication Application Programming Interface (API) provided by an OS when the OS version of the passkey service provision apparatus is equal to or higher than the predefined version.

2. The passkey service provision apparatus of claim 1, wherein, when the OS version of the passkey service provision apparatus is lower than the predefined version, the passkey agent library is further configured to convert request data included in the passkey authentication request into first intent information and deliver the first intent information to the passkey agent.

3. The passkey service provision apparatus of claim 2, wherein the passkey agent is configured to: convert the delivered first intent information into a format identical to that of the passkey authentication API provided by the OS; process the passkey authentication request, generate first intent result information as a response to the passkey authentication request; and deliver the first intent result information to the passkey agent library.

4. The passkey service provision apparatus of claim 3, wherein the passkey agent is further configured to process the passkey authentication request by providing a custom user interface (UI) identical to a system popup called by the OS.

5. The passkey service provision apparatus of claim 3, wherein the passkey agent library is further configured to return, to the service application, a value obtained by converting the first intent result information into the format identical to that of the passkey authentication API.

6. The passkey service provision apparatus of claim 3, wherein the passkey agent is further configured to: determine whether a passkey for processing the passkey authentication request exists after converting the delivered first intent information into the format identical to that of the passkey authentication API; and when the passkey does not exist, generate intent result information indicating failure to process the passkey authentication request as a response to the first intent information and deliver the intent result information to the passkey agent library.

7. The passkey service provision apparatus of claim 6, wherein
the passkey agent library is further configured to return, to the service application, a value obtained by converting the intent result information indicating failure to process the passkey authentication request into the format identical to that of the passkey authentication API,
the service application is further configured to generate a passkey generation request by calling the passkey agent library, and
the passkey agent library is further configured to deliver the passkey generation request to the passkey agent using the IPC method.

8. The passkey service provision apparatus of claim 7, wherein
when the OS version of the passkey service provision apparatus is lower than the predefined version, the passkey agent library is further configured to convert request data included in the passkey generation request into second intent information and deliver the second intent information to the passkey agent,
the passkey agent is further configured to: convert the delivered second intent information into the format identical to that of the passkey authentication API provided by the OS; process the passkey generation request; and generate second intent result information as a response to the passkey generation request and deliver the second intent result information to the passkey agent library, and
the passkey agent library is further configured to return, to the service application, a value obtained by converting the second intent result information into the format identical to that of the passkey authentication API.

9. The passkey service provision apparatus of claim 1, wherein before the generation of the passkey authentication request by the service application, the passkey agent library is further configured to: deliver an account inquiry request generated by the service application to the passkey agent; obtain, from the passkey agent, information on whether a user account is activated from the passkey agent and notify the service application of the obtained information as a response to the account inquiry request; and when the user account is determined not to be activated, allow the passkey agent to perform registration and authentication of the user account by delivering an account activation request generated by the service application to the passkey agent.

10. The passkey service provision apparatus of claim 1, wherein
the passkey agent library is further configured to perform verification on a request generated by the service application by communicating with a service server that provides services to the service application, and
the passkey agent is further configured to store, in a secure area of the OS, information on a passkey generated in response to the request from the service application by communicating with a passkey provider server that provides a passkey management service.

11. A passkey service provision method that provides compatibility between operating system (OS) versions, performed by a computing device including a service application, a passkey agent, and a passkey agent library, the passkey service provision method comprising:
generating, by the service application, a passkey authentication request by calling the passkey agent library;
delivering, by the passkey agent library, the passkey authentication request to the passkey agent using an inter-process communication (IPC) method when an operating system (OS) version of the computing device is lower than a predefined version; and
delivering, by the passkey agent library, the passkey authentication request to the passkey agent by calling a passkey authentication Application Programming Interface (API) provided by the OS when the OS version of the computing device is equal to or higher than the predefined version.

12. The passkey service provision method of claim 11, wherein the delivering of the passkey authentication request to the passkey agent using the IPC method comprises: converting, by the passkey agent library, request data included in the passkey authentication request into first intent information; and delivering the first intent information to the passkey agent.

13. The passkey service provision method of claim 12, further comprising:
converting, by the passkey agent, the delivered first intent information into a format identical to that of the passkey authentication API provided by the OS;
processing, by the passkey agent, the passkey authentication request;
generating, by the passkey agent, first intent result information as a response to the passkey authentication request; and
delivering the first intent result information to the passkey agent library.

14. The passkey service provision method of claim 13, wherein the processing of the passkey authentication request comprises processing, by the passkey agent, the passkey authentication request by providing a custom user interface (UI) identical to a system popup called by the OS.

15. The passkey service provision method of claim 13, further comprising:
returning, by the passkey agent library, a value obtained by converting the first intent result information into the format identical to that of the passkey authentication API to the service application.

16. A computing device comprising:
at least one processor;
a memory configured to load a computer program executed by the at least one processor; and
a storage configured to store the computer program,
wherein the computer program includes instructions for performing operations of:
generating a passkey authentication request by having a service application call a passkey agent library; delivering the passkey authentication request to a passkey agent using an inter-process communication (IPC) method when an operating system (OS) version of the computing device is lower than a predefined version; and delivering the passkey authentication request to the passkey agent by calling a passkey authentication Application Programming Interface (API) provided by an OS when the OS version of the computing device is equal to or higher than the predefined version.

17. The computing device of claim 16, wherein the delivering of the passkey authentication request to the passkey agent using the IPC method comprises: converting, by the passkey agent library, request data included in the passkey authentication request into first intent information; and delivering the first intent information to the passkey agent.

18. The computing device of claim 17, wherein the computer program further includes instructions for performing operations of: converting, by the passkey agent, the delivered first intent information into a format identical to that of the passkey authentication API provided by the OS, and processing the passkey authentication request; and generating first intent result information as a response to the passkey authentication request, and delivering the first intent result information to the passkey agent library.

19. The computing device of claim 18, wherein the processing of the passkey authentication request comprises processing, by the passkey agent, the passkey authentication request by providing a custom user interface (UI) identical to a system popup called by the OS.

20. The computing device of claim 18, wherein the computer program further includes instructions for performing an operation of: returning, by the passkey agent library, a value obtained by converting the first intent result information into the format identical to that of the passkey authentication API to the service application.
